(19) United States
(12) Patent Application Publication
(10) Pub. No.: US 2024/0401287 A1
(43) Pub. Date: Dec. 5, 2024

(54) SLIPFORM PAVER

(71) Applicant: Wirtgen GmbH, Windhagen (DE)

(72) Inventors: Philip VERHAELEN, Lohmar (DE); Michael ENGELS, Montabaur (DE); Gunnar RAMSEGER, Borod (DE); Christian SCHOLL, Dietrichingen (DE)

(21) Appl. No.: 18/673,767

(22) Filed: May 24, 2024

(30) Foreign Application Priority Data
May 30, 2023 (DE) 10 2023 114 147.3

(51) Int. Cl. E01C 19/48; E01C 19/00; G05D 1/622

(52) U.S. Cl. CPC E01C 19/4893; E01C 19/004; G05D 1/637

(57) ABSTRACT

A slipform paver includes at least one machine frame and at least three travelling devices connected to the machine frame. At least one conveyor is connected to the machine frame such that the conveyor is pivotable relative to the machine frame about a horizontal axis and about a vertical axis. At least one first actuator is configured to pivot the conveyor about the horizontal axis and at least one second actuator is configured to pivot the conveyor about the vertical axis, such that the conveyor is movable by at least the first actuator and the second actuator within a zone of movement defined relative to the machine frame. A controller is configured to define at least one area of collision within the zone of movement and to determine a position of the conveyor relative to the area of collision.

### RELATED APPLICATIONS

This application claims priority to German Patent Application Ser. No. DE 10 2023 114 147.3 filed May 30, 2023, which is incorporated herein by reference.

### BACKGROUND OF THE DISCLOSURE

### Field of the Disclosure

The disclosure relates to a slipform paver, and to a method for the construction of ground pavements or structures by means of slipform pavers.

### Description of the Prior Art

Slipform pavers are known, in particular from DE 199 57 048 (U.S. Pat. No. 6,481,924), which comprise at least one machine frame, travelling devices that are connected to the machine frame, and at least one conveying device. The conveying device can be used, for example, to transport concrete to a working device. The working device can be used to construct ground pavements or structures. The working device may be, for example, a concrete mold. The working device may be exchangeable and may also be alterable in position or extended. The travelling devices may be connected to the machine frame in such a manner that they can change their position in relation to the machine frame.

The conveying device may be connected to the machine frame in such a manner that the conveying device is pivotable, relative to the machine frame, at least about a horizontal axis and at least about a vertical axis, and is preferably movable translationally in at least a first direction. Actuators may move the conveying device about the respective axes and, if necessary, in the respective direction. The conveying device is movable, by means of the actuators, within a zone of movement defined in relation to the machine frame.

The conveying device comprises a material reception area for the reception of concrete. The concrete is then transported, via the conveying device, to the working device, in particular to the concrete mold, which is used to construct the ground pavement or structure.

With the known slipform pavers, there is frequently the problem that the operator must control both the slipform paver as such and the conveying device that is part of the slipform paver, which is used to convey the material that is placed in the concrete mold. There is thus an increasing requirement to simplify the operation of the conveying device.

### SUMMARY OF THE DISCLOSURE

It is therefore the object of the present disclosure to create a slipform paver and a method for the construction of ground pavements or structures by means of slipform pavers that simplifies the operation of the entire slipform paver, in particular the operation of the conveying device.

The disclosure advantageously provides that at least one controller is provided, which is configured to define at least one first area of collision within the zone of movement of the conveying device, wherein the controller is furthermore configured to determine the position of the conveying device relative to the area of collision.

The zone of movement is the space, relative to the machine frame, within which the conveying device can theoretically move, and is necessarily determined by the design of the conveying device and the actuators moving said conveying device. According to the present disclosure, at least one first actuator is provided which is arranged and configured in such a manner that the conveying device is pivotable at least about the horizontal axis. Furthermore, a second actuator is provided which is arranged and configured in such a manner that the conveying device is pivotable at least about the vertical axis.

As the conveying device can be flexibly moved and positioned within the zone of movement by means of the actuators, material can be reliably transported to the working device by means of the conveying device. Both the point of reception where the material is transferred to the conveying device and the position where the material is transferred to the working device are flexible in this design.

Also, at least one third actuator may be provided, which is arranged and positioned in such a manner that the conveying device is movable translationally in at least the first direction.

The area of collision is an area within the zone of movement. The area of collision is an area into which the conveying device should not move. Said area may be an area, for example, in which a collision of the conveying device with at least one object may occur. Said object may be a part of the slipform paver, for example, such as, for example, a travelling device. In this case, the object would actually be located within the area of collision. On the other hand, this may also be a theoretical danger of a collision with an object. On a carriageway, for example, there could be an area located within the zone of movement, in which vehicles, for example, site vehicles, or other objects may be moved. In this case, a specific area of collision may be defined, in which a collision may theoretically occur.

The position of the conveying device in the zone of movement, in particular the position of the conveying device relative to the area of collision, may be determinable based on the adjustment position of the actuators. The controller may be configured to emit a control signal as soon as it is established by means of the controller that the conveying device comes within a predetermined distance from the area of collision.

The position of the conveying device in the zone of movement may be effected, for example, by means of sensors arranged on the actuators. The sensors may, for example, be arranged integrated in the actuators, or arranged separate from the same. Integrated sensors may be, for example, displacement measuring cylinders. Separately arranged sensors may be, for example, wire-rope sensors.

Alternatively or additionally, sensor technology in the form of a 3D camera or distance sensors, which may, for example, be arranged on the machine frame, may also be provided to detect the position.

Additional actuators other than the at least one first actuator, the at least one second actuator, and the at least one third actuator may also be provided. If additional actuators are provided, the zone of movement is the space in which the conveying device may be moved by moving the first, second, third and additional actuators. It is not excluded in this arrangement that more than one additional actuator may be provided. To define the zone of movement, all degrees of freedom of the conveying device and therefore all actuators involved in the adjustment must be taken into account.

The control signal may be a stop signal to stop at least one actuator and/or a control signal for emitting an audible and/or a visual warning signal. It could also be possible, for example, to emit a plurality of different control signals. For this purpose, it is also possible to specify different distances and to emit different control signals as a function of the distance determined.

In one step, for example, a warning in the form of an audible and/or visual signal could be emitted at a specific first distance. In a second step, at a second predetermined distance, which is preferably smaller than the first predetermined distance, a stop signal may then be emitted to stop the at least one actuator.

At least one part of the machine frame and/or at least one part of a ground-engaging unit may be arranged within the area of collision.

The machine frame may be configured in such a manner that the structure of the machine frame is alterable by adding and/or removing assembly groups. Alternatively or additionally, the machine frame may also be configured in such a manner that parts thereof, in particular the ground-engaging units, are adjustable so that the structure of the machine frame is alterable.

As a result, it may also be necessary to adapt the area of collision.

The controller may be configured to adapt the area of collision defined within the zone of movement, wherein said adaptation is performable manually or automatically.

The controller may be configured to adapt the area of collision if there is a change in the position and/or the structure of at least one ground-engaging unit and/or in the structure of the machine frame. If the ground-engaging unit and/or the structure of the machine frame is within the area of the zone of movement of the conveying device, a collision may theoretically occur. According to the present disclosure, an area of collision may be defined that is located within the zone of movement. It may be prevented that the conveying device moves into said area of collision. As a result of the position and structure of the ground-engaging unit or the structure of the machine frame being alterable, it may be necessary to adapt the area of collision. The area of collision of the slipform paver may be adapted manually or automatically. In the case of automatic adaptation, the area of collision may be adapted automatically, for example, whenever the position and structure of the ground-engaging unit changes relative to the machine frame. The position and structure may, for example, be detected automatically by means of sensors. Alternatively, for example, the input commands for an adjustment device may be detected, which, for example, pivots the ground-engaging units relative to the machine frame.

It may be stored in a storage device which assembly groups of the machine frame can be added or removed, respectively, so that the different structures of the machine frame are storable in the storage device, wherein the area of collision is adaptable by selecting the different structures of the machine frame from the storage device.

Assembly groups may be, for example, different or extendable working devices, in particular concrete molds. Different configurations and therefore different areas of collision may be stored, for example, for different working devices, in particular concrete molds. Different configurations may be understood to mean, for example, different types of machine configurations. When a machine exhibits a different configuration, it may, for example, exhibit a different working device, for example, a different concrete mold, or the ground-engaging units may be positioned differently relative to the machine frame. The working device, in particular concrete mold, currently in use may be selected by the operator by means of an input device, for example, and the area of collision may be adapted accordingly.

It may also be provided that the working devices, in particular concrete molds, themselves carry a readable identifier (barcode/RFID etc.), which may be read out when mounting the working device, in particular concrete mold, on the machine. In this case, the operator does not have to manually select the working device used.

The information on the assembly group may in particular include length/height/width of the assembly group and the mounting position.

Different configurations and therefore different areas of collision may be stored in the storage device for different applications of the slipform paver, wherein the area of collision is adaptable by selecting the different applications. Different machine frame structures may be used in different applications, for example, so that the area of collision is adaptable automatically by simply selecting the application.

The controller may be configured to determine the overlapping areas of the zone of movement of the belt conveyor and the space occupied by the machine frame and the ground-engaging units in order to specify the area of collision and/or to adapt the area of collision.

In this design, determination of the overlapping area may initially be specified at the beginning of a working process, and the area of collision may subsequently be adapted manually or automatically as described above.

Not only the ground-engaging units may be movable parts of the machine. The working device, such as a concrete mold, may, for example, also be configured as a movable part of the machine. Other parts of the machine may also be configured as movable parts of the machine. The area of collision may change as a result of the movable parts.

Alternatively, the control system may also conduct a check of the overlapping area once again during the working operation. Alternatively, the controller may also be configured to adapt the overlapping area specifiable as the area of collision automatically in the event that the ground-engaging units or other parts of the machine are moved. This means that the overlapping area is determined continuously. Continuous determination may be effected, for example, by means of sensors.

Sensors may be provided, for example, which detect the position of the ground-engaging units and the machine frame or also other objects and transmit signals to the controller, and the controller, as a function thereof, defines an area of collision or defines an area of collision changing over time, respectively. The sensor data may be taken into account for determining the area of collision.

Alternatively, such detection by means of sensors may be effected once at the beginning of a working process. Additionally, the altered position of the travelling devices and/or the machine frame may then be adapted during the working process using the altered predetermined control inputs, such as steering inputs.

According to the present disclosure, a method may be provided for the construction of ground pavements or structures by means of slipform pavers, which comprises at least one machine frame, to which at least one conveying device is connected, wherein the conveying device is pivotable, relative to the machine frame, at least about a horizontal axis and at least about a vertical axis, wherein at least one first actuator may pivot the conveying device at least about the horizontal axis, and at least one second actuator may pivot the conveying device at least about the vertical axis, wherein the conveying device is movable, by means of at least the first and second actuator, within a zone of movement defined in relation to the machine frame. According to the present disclosure, it may be provided that at least one first area of collision is defined within the zone of movement by means of a controller, and wherein the position of the conveying device relative to the area of collision is determined by means of the controller.

It may also be provided that the conveying device may be moved translationally in at least a first direction relative to the machine frame, and at least one third actuator may move the conveying device translationally at least in the first direction, wherein the conveying device may be movable by means of at least the first and second and, optionally, also the third actuator within a zone of movement defined in relation to the machine frame.

The position of the conveying device relative to the area of collision may be determined based on the adjustment position of the actuators.

The controller may emit a control signal as soon as the conveying device comes within a predetermined distance from the area of collision.

The control signal may be a stop signal to stop at least one actuator and/or a control signal for emitting an audible and/or visual warning signal. The area of collision defined within the zone of movement may be adapted manually and/or automatically.

The area of collision may be adapted if there is a change in the position and/or the structure of at least one ground-engaging unit and/or in the structure of the machine frame.

In the following, one embodiment of the present disclosure is explained in more detail with reference to the drawings.

### BRIEF DESCRIPTION OF THE DRAWINGS

The following is shown schematically:

FIG. 1 a top view of a slipform paver,

FIG. 2 a perspective view of a conveying device,

FIG. 3 a side view of the conveying device according to FIG. 2,

FIG. 4 the conveying device according to FIG. 3 in extended transport belt,

FIG. 5 a conveying device according to FIG. 3 in adjusted position,

FIG. 6 a conveying device according to FIG. 4 in side view and, for a better depiction, without transport belt, and

FIG. 7 a further view from below of the conveying device according to FIG. 6,

FIG. 8 a controller.

### DETAILED DESCRIPTION

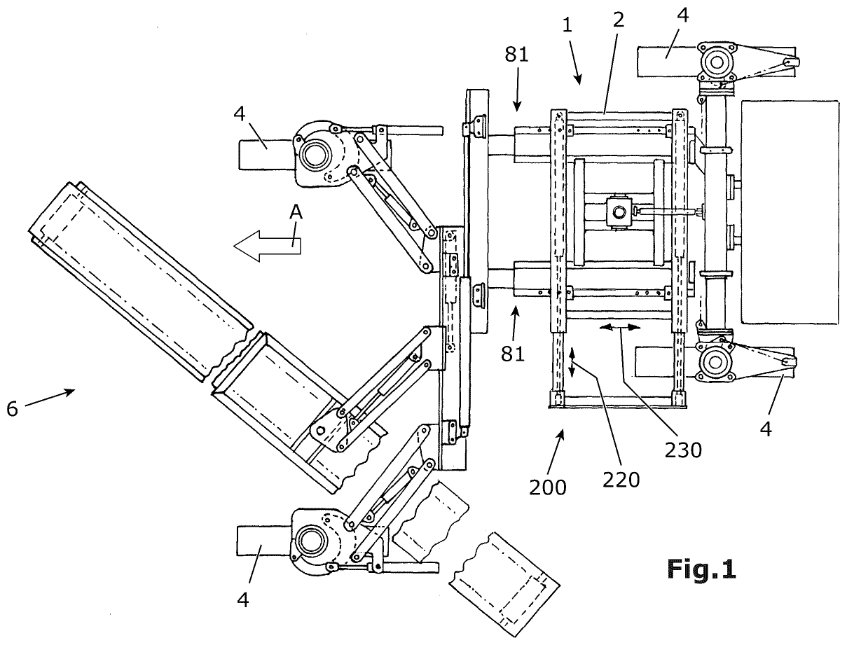

FIG. 1 shows a slipform paver 1. A slipform paver can be used to construct ground pavements or structures. The slipform paver 1 can move in the direction of operation A.

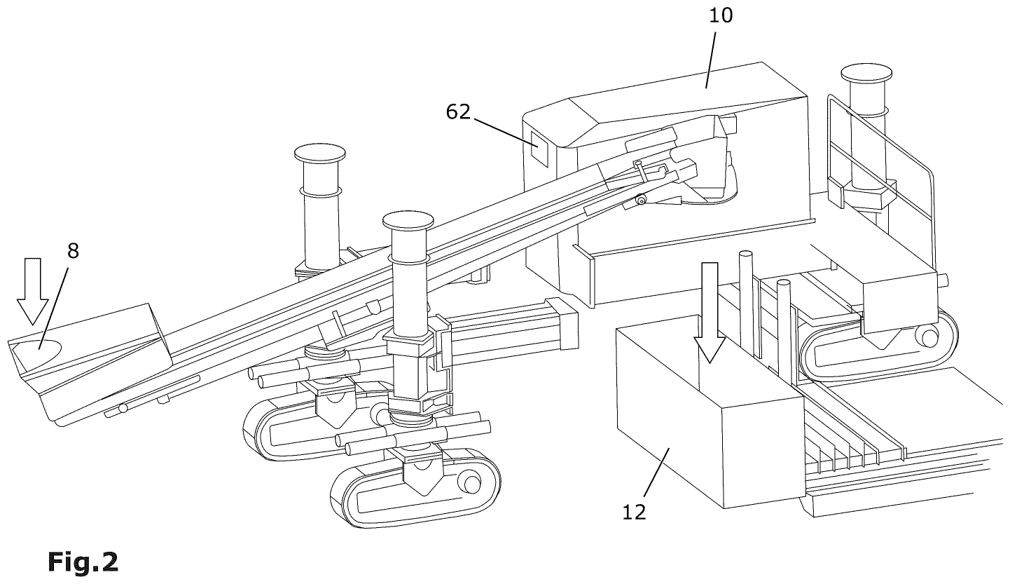

The slipform paver 1 comprises at least one machine frame 2. Travelling devices 4 are connected to the machine frame 2. Furthermore, at least one conveying device 6 is provided. The conveying device 6 may also be referred to as a conveyor 6. The conveying device 6 can be used, for example, to transport concrete to a working device 12 (FIG. 2). The working device can be used to construct ground pavements or structures. The working device may be, for example, a concrete mold. The working device may be exchangeable and may also be alterable in position or extended. The travelling devices 4 may be connected to the machine frame in such a manner that they can change their position in relation to the machine frame.

A slipform paver 1 is depicted in FIG. 1, in which the longitudinal members 81 of the machine frame 2 are variable in length. Furthermore, the machine frame 2 also comprises a machine frame part 200, which is variable in length in the longitudinal direction 230 and in the transverse direction 220. Different working devices 12, for example, concrete molds of different shapes, may be attached to said machine frame part 200. These may be positioned differently by means of the machine frame part 200.

The conveying device 6 may be connected to the machine frame 2 in such a manner that the conveying device 6 is pivotable, relative to the machine frame, at least about a horizontal axis and at least about a vertical axis. As depicted in the embodiment, the conveying device 6 may also be movable translationally in at least a first direction relative to the machine frame.

Material may be received by means of the conveying device 6 and conveyed into the working device 12 used to construct the pavement or structures.

In FIG. 2, the conveying device 6 is depicted in more detail, in which the material is received on the side 8 and is placed in the working device 12 configured as a concrete mold on the side 10.

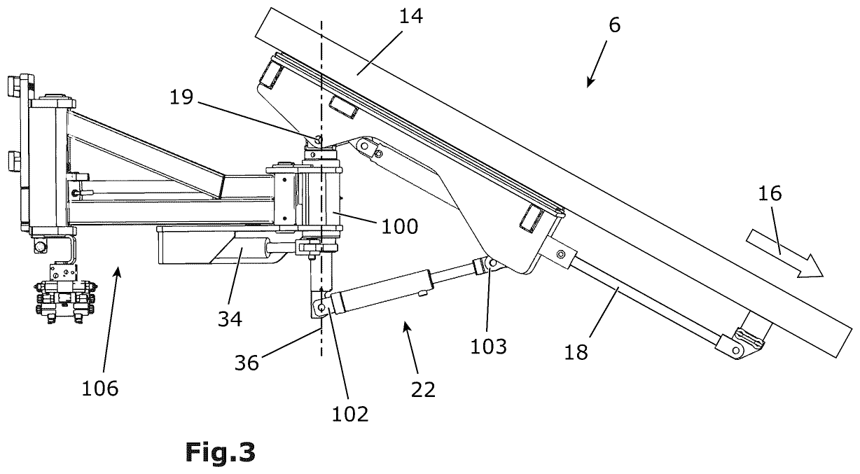

The conveying device 6 is depicted in more detail in FIG. 3. The conveying device 6 comprises a belt conveyor 14, which is shown in FIG. 3. The belt conveyor 14, and therefore the conveying device 6, may be pivoted about a horizontal pivoting axis 19 by means of at least one first actuator 22. Furthermore, the conveying device 6 may be pivoted about a vertical pivoting axis 36 by means of a second actuator 34. Moreover, the conveying device 6 may also be movable translationally in at least a first direction 16 by means of a third actuator 18. In this design, depending on the embodiment, the belt conveyor 14 may be moved in the first translational direction 16 either as a whole or merely one end of the belt conveyor 14, which makes it possible to lengthen the belt conveyor. Alternatively, both could also be possible.

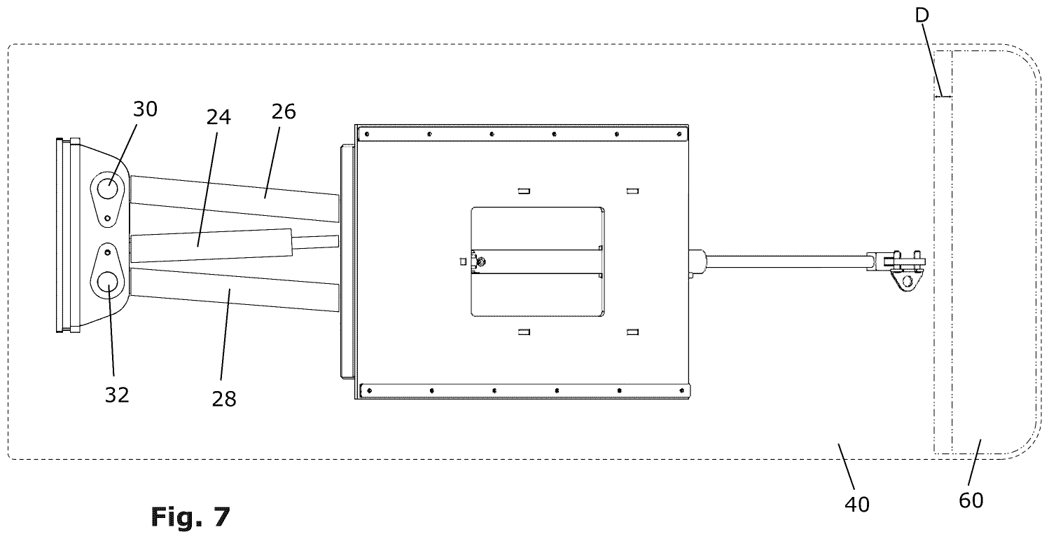

Furthermore, the conveying device 6 is arranged on a parallelogram guide 106, by means of which the entire conveying device 6 may be adjusted with the aid of an additional actuator 24 not depicted in FIG. 3. This will be explained in more detail with reference to FIG. 7. The parallelogram guide 106 is arranged on the machine frame 2.

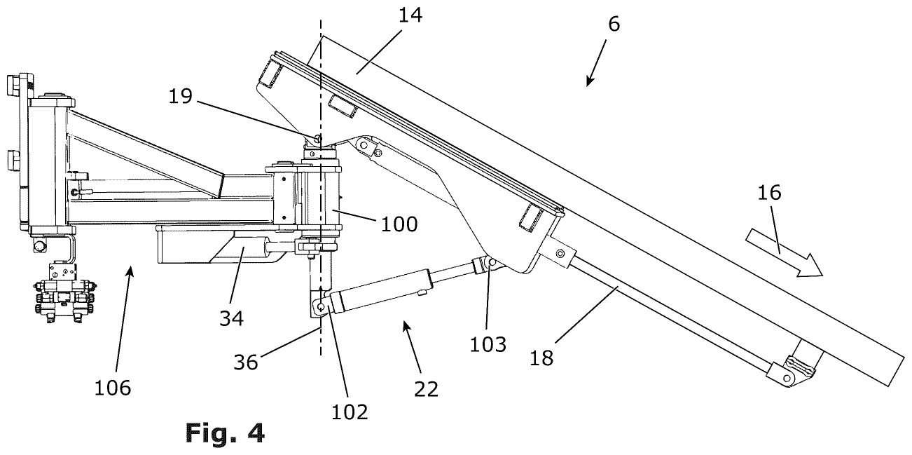

FIG. 4 shows the embodiment according to FIG. 3 with the belt conveyor moved in the translational direction 16, in which the belt conveyor as a whole has been moved in the translational direction 16.

FIG. 4 furthermore depicts the at least first actuator 22, which may pivot the conveying device 6 about the pivoting axis 19, wherein the axis 19 is preferably a horizontal axis. In this design, the pivoting axis 19 is preferably arranged below the belt conveyor 14. As depicted in the embodiment, the pivoting axis 19 may be arranged in the upper third of the conveying device 6. In a further preferred embodiment, the pivoting axis 19 may be arranged in the area of the middle third of the conveying device 6. In the embodiment depicted, the depicted first actuator 22 is mounted on a connection element 100 to pivot about a pivoting axis 102. The connection element 100 is arranged on a parallelogram guide 106. The first actuator 22 is furthermore connected to the conveying device 6 on a second end to pivot about a pivoting axis 103. The conveying device may also be movable translationally along the axis 36 manually or by means of an additional actuator.

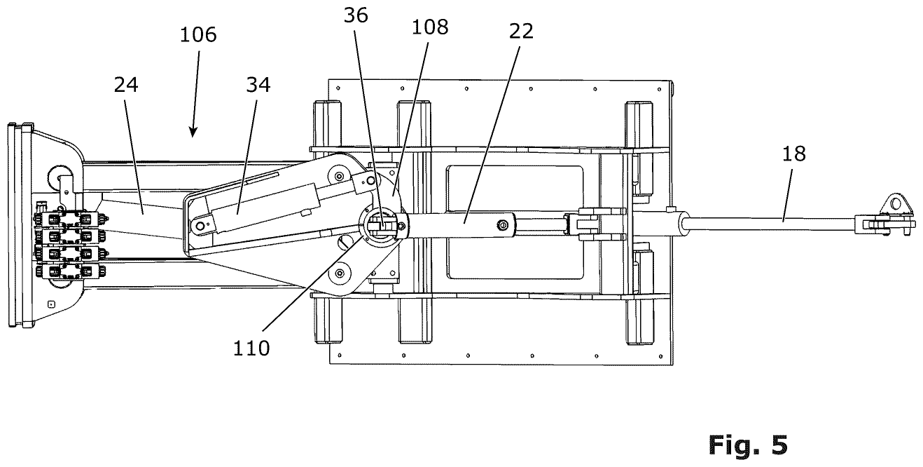

FIG. 5 shows a view of the embodiment from below. However, the belt conveyor is not depicted for reasons of clarity. The view shows the at least one first actuator 22, the at least one second actuator 34 and the at least one third actuator 18. The second actuator 34 may pivot the conveying device 6 about the vertical pivoting axis 36. The pivoting axis 36 preferably intersects the belt conveyor. Furthermore, the pivoting axis 36 may extend through the pivoting axis 19. This can also be inferred from FIG. 4. In the embodiment depicted, the second actuator is connected, on a first end, to the parallelogram guide 106. On a second end, the second actuator 34 is connected in a pivotable manner to a connecting link 108, which is in turn connected to a hollow column 110, which is connected to the conveying device 6. By operating and extending or retracting the second actuator 34, respectively, the hollow column 110, and thus the conveying device 6, may be pivoted about the pivoting axis 36.

Furthermore, an optional additional actuator 24 is also depicted in FIG. 5. It can be used to adjust the entire conveying device 6 with the parallelogram guide 106. The parallelogram guide 106 is arranged on the machine frame 2.

If the machine does not comprise the optional additional actuator 24 and the parallelogram guide 106, the axis 36 may also be arranged on the machine frame.

Since the conveying device may be flexibly moved and positioned within the zone of movement at least by means of the actuators 22, 18, 34, 24, material can be reliably transported to the working device by means of the conveying device 6. The point of reception, where the material is transferred to the conveying device 6, is flexible in this design, as is the position where the material is transferred to the working device 12.

Horizontal within the meaning of the present disclosure does not necessarily mean horizontal relative to the ground surface but horizontal means parallel to a plane defined by the longitudinal and transverse axes of the machine frame.

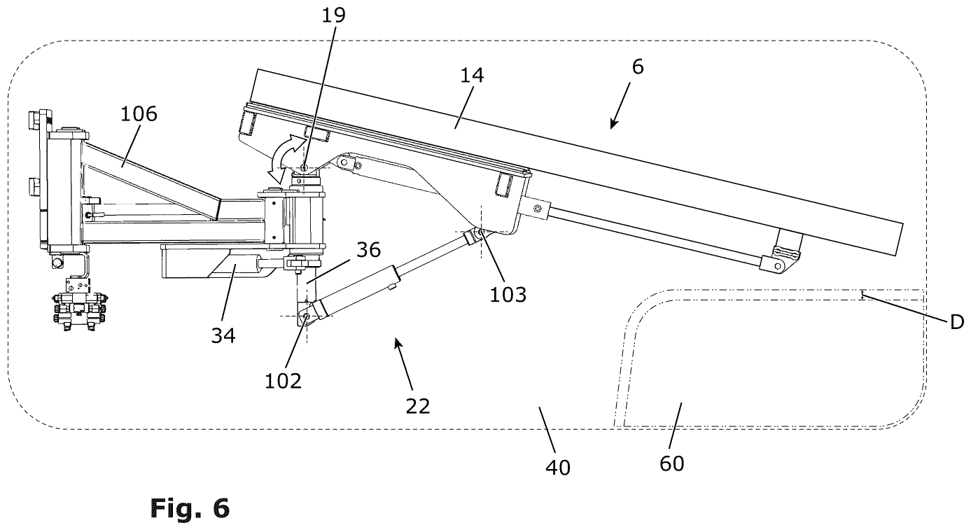

FIG. 6 shows the conveying device according to FIG. 4, but in adjusted position. In FIG. 6, the at least first actuator 22 has been adjusted in comparison with FIG. 4. FIG. 6 furthermore depicts a zone of movement 40. In this context, the zone of movement 40 is the space in which the conveying device 6 may be moved by moving the at least first, second and third actuators. It is therefore the space within which the conveying device 4 can theoretically move. The zone of movement 40 is defined in relation to the machine frame. If the slipform paver, and therefore the machine frame, move forward, the zone of movement 40 will, as a result, also move forward. The zone of movement 40 is necessarily determined by the design of the conveying device and the actuators moving said conveying device. FIG. 6 only depicts the zone of movement in side view.

An area of collision 60 may now be definable within the zone of movement. The area of collision 60 is an area within the zone of movement 40 into which the conveying device 6 should not move. Said area of collision 60 may, for example, be an area in which a collision of the conveying device 6 with the machine frame 2 or a travelling device 4 or at least any other object may occur.

FIG. 7 shows a top view of the conveying device 6; however, no belt conveyor 14 is depicted for reasons of clarity. Said top view depicts the optional additional actuator 24. Said additional actuator 24 may pivot the entire conveying device 6 in parallel. In the present embodiment, the optional additional actuator 24 pivots the conveying device by means of the parallelogram guide 106. In FIG. 7, the two links 26 and 28 are depicted, each of which pivots about an axis of rotation 30 and 32.

FIG. 7 depicts the zone of movement 40 and the area of collision 60 in top view. However, the zone of movement 40 and the zone of collision are only depicted in a specific horizontal plane. The spatial extension of the zone of collision 60 and 40 outside said plane cannot be depicted in this top view.

The conveying device 6 may be moved within the zone of movement 40 defined relative to the machine frame 2 by means of the at least one first actuator 22, at least one second actuator 34 and at least one third actuator 18. As depicted in the embodiment, the conveying device 6 may optionally also be moved within the zone of movement 40 defined relative to the machine frame 2 by means of the at least one third actuator 18. The zone of movement 40 is depicted in FIGS. 6 and 7. If additional actuators are provided, such as, for example, the additional actuator 24, the zone of movement 40 is the space in which the conveying device 6 may be moved by moving the first actuator 22, second actuator 34, third actuator 18 and additional actuator 24. It is not excluded in this arrangement that more than one additional actuator may also be provided. To define the zone of movement, all degrees of freedom of the conveying device and therefore all actuators involved in the adjustment must be taken into account.

Furthermore, the area of collision 60 is also depicted in the zone of movement 40. The area of collision 60 is the area within the zone of movement 40 into which the conveying device 6 should not move. Said area of collision 60 may, for example, be an area in which a collision of the conveying device 6 with the machine frame 2 or a travelling device 4 or at least any other object may occur. In general terms, the area of collision defines a partial area of the zone of movement into which a movement of the conveying device 6 should not occur.

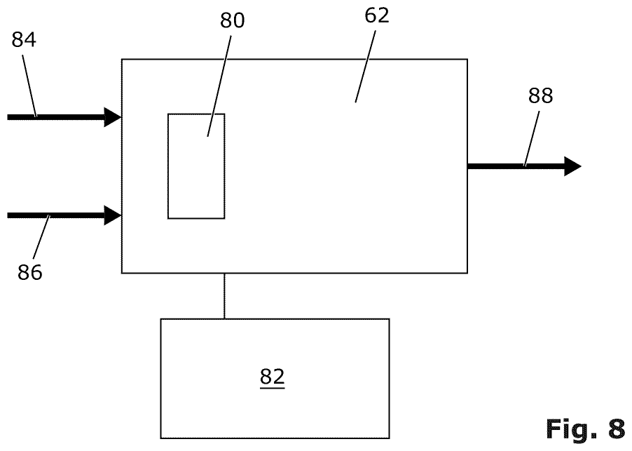

A controller 62 is depicted in more detail in FIG. 8. The controller 62 is configured to define at least one first area of collision 60 within the zone of movement 40, wherein the controller 62 is furthermore configured to determine the position of the conveying device 6 relative to the area of collision 60.

The controller 62 depicted preferably comprises a storage device 80 (which may also be referred to as a computer-readable medium), in which data representative of the zone of movement 40 and the area of collision 60 are storable.

The controller 62 also includes or may be associated with a processor, a data base and the input/output module or control panel having a display. It is understood that the controller 62 described herein may be a single controller having all of the described functionality, or it may include multiple controllers wherein the described functionality is distributed among the multiple controllers.

Various operations, steps or algorithms as described in connection with the controller 62 can be embodied directly in hardware, in a computer program product such as a software module executed by the processor, or in a combination of the two. The computer program product can reside in RAM memory, flash memory, ROM memory, EPROM memory, EEPROM memory, registers, hard disk, a removable disk, or any other form of computer-readable medium 80 known in the art. An exemplary computer-readable medium 80 can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The data storage in computer readable medium 80 and/or database may in certain embodiments include a database service, cloud databases, or the like. In various embodiments, the computing network may comprise a cloud server, and may in some implementations be part of a cloud application wherein various functions as disclosed herein are distributed in nature between the computing network and other distributed computing devices. Any or all of the distributed computing devices may be implemented as at least one of an onboard vehicle controller, a server device, a desktop computer, a laptop computer, a smart phone, or any other electronic device capable of executing instructions. A processor (such as a microprocessor) of the devices may be a generic hardware processor, a special-purpose hardware processor, or a combination thereof.

The controller 62 may furthermore be connected to an input device 82, by means of which the machine configuration may be entered, for example, and/or the at least one area of collision 60 and/or the entries for the actuators may be entered. Sensor signals 84 may also be transmitted to the controller 62. Said sensor signals 84 may be, for example, the position signals of the conveying device 6. Additional sensor signals 86 may also be transmitted to the controller 62. Said additional sensor signals 86 may be the sensor signals relating to the position and/or size of the working device and/or travelling devices 4. The controller 62 may emit at least one control signal 88, which will be described in more detail below.

The controller 62 may be configured to determine the position of the conveying device 6 relative to the area of collision 60. As described earlier, the area of collision 60 is an area into which the conveying device 6 should not move. Said area may be an area, for example, in which a collision with any object may occur. Said object may also be a part of the slipform paver 1, such as, for example, the machine frame 2 or the travelling devices 4. In the embodiment depicted in FIGS. 5 and 6, for example, a part of the travelling device 4 of the slipform paver, for example, could be arranged within the zone of movement 40.

The position of the conveying device 6 relative to the area of collision 60 may be determinable, for example, at least based on the adjustment position of the first actuator 22 and second actuator 34. If a third actuator 18 and/or additional actuators 24 are used, the adjustment positions of said actuators may also be included.

The controller 62 may be configured to emit a control signal 88 as soon as it is established that the conveying device comes within a predetermined distance from the area of collision. This could be the distance D, for example, depicted in FIGS. 6 and 7.

The control signal 88 may be a stop signal to stop at least one of the actuators and/or a control signal for emitting an audible and/or visual warning signal.

Furthermore, a plurality of steps may also be provided so that, in a first step, a control signal may be emitted at a specific first distance D, which generates a warning of an audible and/or visual signal. In a second step, for example, at a second predetermined distance E, which is preferably smaller than the first predetermined distance, a stop signal may then be emitted to stop the at least one actuator.

The zone of movement 40 is preferably definable relative to the machine frame 2 and moves forward with the slipform paver together with the forward movement of the slipform paver 1. During the forward movement of the slipform paver 1, however, the area of collision 60 within the zone of movement 40 may also change. This may occur, for example, as a result of the travelling devices 4 moving relative to the machine frame 2 and changing their position in relation to the machine frame 2. This could also occur, for example, as a result of theoretical areas of collision changing, into which the conveying device 6 should not move. Theoretical areas of collision may be areas on a road, for example, such as the opposite lane, for example, into which the conveying device 6 should not move. A change in the area of collision 60 may also occur due to the fact that the structure of the machine frame 2 may change. With different functions of the slipform paver 1, the machine frame 2 may also be configured differently so that the area of collision is alterable also subject to the function of the slipform paver. The area of collision may therefore be adaptable in terms of time.

The area of collision may also be specified by the operator, for example, by means of the input device 82. On a construction site, for example, a specific area (such as the opposite carriageway or obstacles on the carriageway) may be defined as the area of collision. Such specification may also be effected by means of a “teach-in” procedure. The operator may, for example, specify boundaries of the movement of the conveying device 6.

In one embodiment, sensors 70 may also be provided, which detect the position of the ground-engaging units and the machine frame or also objects and transmit signals 86 to the controller 62, and the controller 62, as a function thereof, defines an area of collision 60 or defines an area of collision 60 changing over time, respectively. The sensor data may be taken into account for determining the area of collision 60.

Alternatively, such detection by means of sensors 70 may be effected once at the beginning of a working process. Additionally, the altered position of the travelling devices 4 and/or of the machine frame 2 may then be adapted during the working process using the altered predetermined control inputs, such as steering inputs.

As an alternative, for example, at the start of a working process, the operator may also define parts within the area of the zone of operation that is to be defined as the area of collision. The area of collision within the zone of movement may then be adapted manually or also automatically.

The area of collision may also be predetermined manually independent of the machine configuration, for example, in order to prevent the conveying device from protruding into the opposite carriageway.

What is claimed is:

1: A slipform paver, comprising:
at least one machine frame;
at least three travelling devices connected to the machine frame;
at least one conveyor connected to the machine frame such that the conveyor is pivotable relative to the machine frame about a first axis and about a second axis;
at least one first actuator configured to pivot the conveyor about the first axis and at least one second actuator configured to pivot the conveyor about the second axis, such that the conveyor is movable by at least the first actuator and the second actuator within a zone of movement defined relative to the machine frame; and
a controller configured to define at least one area of collision within the zone of movement and to determine a position of the conveyor relative to the area of collision.

2: The slipform paver of claim 1, further comprising:
at least one third actuator configured to move the conveyor translationally in a first direction relative to the machine frame, such that the conveyor is movable by at least the first actuator, the second actuator and the third actuator within the zone of movement defined relative to the machine frame.

3: The slipform paver of claim 1, wherein:
each of the actuators has an adjustment position; and
the controller is configured to determine the position of the conveyor relative to the area of collision based at least in part on the adjustment positions of the actuators.

4: The slipform paver of claim 1, wherein:
the controller is configured to emit a control signal when it is determined that the conveyor is within a predetermined distance from the area of collision.

5: The slipform paver of claim 4, wherein:
the control signal includes a stop signal to stop at least one of the actuators and/or a control signal for emitting an audible and/or a visual warning signal.

6: The slipform paver of claim 1, wherein:
the area of collision is defined at least in part by a part of the machine frame and/or one of the travelling devices.

7: The slipform paver of claim 1, wherein:
the controller is configured to manually and/or automatically adjust the area of collision defined within the zone of movement.

8: The slipform paver of claim 7, wherein:
the controller is configured to adjust the area of collision defined within the zone of movement in response to a change in position of one of the traveling devices and/or a change in structure of the machine frame.

9: The slipform paver of claim 8, wherein:
the machine frame is alterable in structure by adding or removing or different positioning of assembly groups.

10: The slipform paver of claim 9, wherein:
the controller includes a computer-readable medium and the controller is configured to store in the computer-readable medium data representative of the assembly groups which may be added or removed or differently positioned, so that the different structures of the machine frame are stored in the computer-readable medium and so that the area of collision is adjustable by selecting one of the different structures of the machine frame from the computer-readable medium.

11: The slipform paver of claim 7, wherein:
the controller includes a computer-readable medium and the controller is configured to store in the computer-readable medium data representative of different areas of collision corresponding to different applications of the slipform paver such that the area of collision is adjustable by selecting one of the different applications.

12: The slipform paver of claim 7, wherein:
the controller is configured to determine and to define as the area of collision an overlapping area of the zone of movement of the conveyor and a space occupied by the machine frame and the travelling devices.

13: A method of constructing ground pavements or structures with a slipform paver, the slipform paver including at least one machine frame, at least one conveyor connected to the machine frame such that the conveyor is pivotable relative to the machine frame about a first axis and about a second axis, at least one first actuator configured to pivot the conveyor about the first axis and at least one second actuator configured to pivot the conveyor about the second axis, such that the conveyor is movable by at least the first actuator and the second actuator within a zone of movement defined relative to the machine frame, the method comprising:
defining with a controller at least one area of collision within the zone of movement; and
determining with the controller a position of the conveyor relative to the area of collision.

14: The method of claim 13, the slipform paver further including at least one third actuator configured to move the conveyor translationally, such that the conveyor is movable by at least the first actuator, the second actuator and the third actuator within the zone of movement defined relative to the machine frame.

15: The method of claim 13, wherein:
the determining with the controller of the position of the conveyor relative to the area of collision is based at least in part on an adjustment position of each of the actuators.

16: The method of claim 13, further comprising:
emitting a control signal with the controller as soon as the conveyor comes within a predetermined distance from the area of collision.

17: The method of claim 16, wherein:
the control signal includes a stop signal to stop at least one of the actuators and/or a control signal for emitting an audible and/or a visual warning signal.
